(19) United States
(12) Patent Application Publication
(10) Pub. No.: US 2016/0369758 A1
(43) Pub. Date: Dec. 22, 2016

(54) DEGASSING FUEL

(71) Applicant: Honeywell International Inc., Morristown, NJ (US)

(72) Inventors: Tyler Jeppesen, Albuquerque, NM (US); Michael Rawson, Albuquerque, NM (US); Timothy Way, Albuquerque, NM (US); James Nickerson, Albuquerque, NM (US)

(21) Appl. No.: 14/744,822

(22) Filed: Jun. 19, 2015

(51) Int. Cl. F02M 37/02; F02M 37/00; B01D 19/00

(52) U.S. Cl. CPC F02M 37/02; B01D 19/00; F02M 37/0076

(57) ABSTRACT

In some examples, a system configured to remove at least some air and other gases that are dissolved in fuel prior to introducing the fuel into a closed fuel system, such as a closed fuel system of an unmanned aerial vehicle. The system includes a vacuum chamber configured to contain a fuel, a vacuum source attached lo the vacuum chamber and configured to draw a vacuum on a headspace over the fuel in the vacuum chamber, and a fuel pump configured to pump the fuel from the vacuum chamber into a closed fuel container without introducing air into the closed fuel container. In some examples, the pump introduces a fuel substantially free of dissolved gases into the closed fuel system.

### STATEMENT REGARDING FEDERALLY SPONSORED RESEARCH OR DEVELOPMENT

This invention was made with Government support under Government Contract N00019-09-C-0004 awarded by the Naval System Air Command. The Government has certain rights in the invention.

### TECHNICAL FIELD

This disclosure generally relates to a closed fuel system for use in system s sue as an unmanned aerial vehicle.

### BACKGROUND

In some cases, an unmanned aerial vehicle (UAV) is gasoline powered and employs a closed fuel container, e.g., a bladder-like container, to store fuel on board. The fuel bladder collapses during flight when fuel is drawn by the engine to help ensure a consistent flow of fuel to the engine regardless of the pitch, yaw, or roll of the UAV.

### SUMMARY

Example devices, systems, and methods for degassing fuel that is introduced into a closed fuel system, such as a closed fuel system of a unmanned aerial vehicle (UAV), are described in this disclosure. In some examples, an electric fueling system includes a first container and a vacuum source configured to draw a vacuum on a volume of fuel in the first container to extract at least some of the air and other gases that are dissolved in the fuel. The electric fueling system is configured to pump the degassed fuel (e.g., at least partially degassed fuel) from the first container into a closed fuel container, e.g., of a UAV, without exposing the fuel to air. Exposing the fuel to air after the air and other gases are extracted from the fuel by the application of the vacuum may cause air to be introduced back into the fuel. In some examples, the volume of fuel in the first container can be agitated, either automatically, or manually, to help increase the amount of air and other gases that are removed from the volume of fuel by the vacuum.

In some examples, the disclosure describes a method including drawing a vacuum on a headspace over a fuel in a first container to at least partially remove a dissolved gas from the fuel, agitating the fuel while the fuel is under the vacuum, and pumping the fuel from the first container into a closed fuel container, where the fuel put ed into the closed fuel container is substantially free of the dissolved gas.

In another example, the disclosure describes a method for filling a closed fuel container including establishing a vacuum pressure on a headspace of a vacuum chamber, introducing a fuel into the vacuum chamber, wherein the fuel partially fills the vacuum chamber, removing a dissolved gas from the fuel to create a degassed fuel, and pumping the degassed fuel into a closed fuel container, where the closed fuel container is substantially free of a gas.

In another example, the disclosure describes system including a vacuum chamber configured to contain a fuel, a vacuum source attached to the vacuum chamber and configured to draw a vacuum on a headspace over the fuel in the vacuum chamber, and a fuel pump configured to pump the fuel from the vacuum chamber into a closed fuel container without introducing air into the closed fuel container.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a schematic diagram illustrating an example electric fueler.

FIG. 2 is a schematic diagram illustrating another example electric fueler.

FIG. 3 is a schematic diagram illustrating another example electric fueler attached to a reinforced fuel canister.

FIG. 4 is a schematic diagram illustrating another example electric feeler attached to a reinforced fuel canister.

FIG. 5 is a conceptual illustration of an example unmanned aerial vehicle.

FIG. 6 is a flow diagram illustrating an example technique for filling a closed fuel container with a degased fuel.

FIG. 7 is a flow diagram illustrating another example technique for filling a closed fuel container with a degased fuel.

### DETAILED DESCRIPTION

The disclosure describes example devices, systems (e.g., electric fueling systems), and methods for fueling a vehicle, such as a UAV or another vehicle or system that requires a metered amount of fuel in a closed fuel container, with a fuel from which at least some of the air and other gases have been removed. The devices and systems described herein are configured to remove at least some gas that is dissolved in a fuel, referred to herein as “degassing” the fuel, by the application of a vacuum on a vacuum chamber that includes the fuel (e.g., another fuel container configured to receive the vacuum). The vacuum may be drawn on the headspace (e.g., the unfilled space above the fuel in the vacuum chamber). The devices, systems, and methods may have the beneficial effects of reducing the amount of time to de-fuel and refuel a closed fuel system, reducing the potential for operator error, as well as improving the quality of fuel introduced into the closed fuel system without altering the ignition characteristics of the fuel.

As used herein, a closed fuel container is a receptacle for fuel that creates a substantially sealed system (e.g., sealed or nearly sealed) that isolates the enclosed fuel from the external atmosphere, e.g., air. While the closed fuel container and closed fuel system are primarily described with respect to a UAV, in other examples, the closed fuel container and closed fuel system may be part of a different vehicle or system. In some examples, the closed fuel container may be in the form of a flexible of collapsible fuel bladder that collapses as fuel is withdrawn from the bladder and supplied to the UAV. In some examples, the closed fuel container may substantially eliminate (e.g., completely eliminate or nearly completely eliminate) the headspace in the container (e.g., the unfilled space above the fuel in the fuel container) so that the closed fuel container consists essentially of the enclosed fuel in a liquid state.

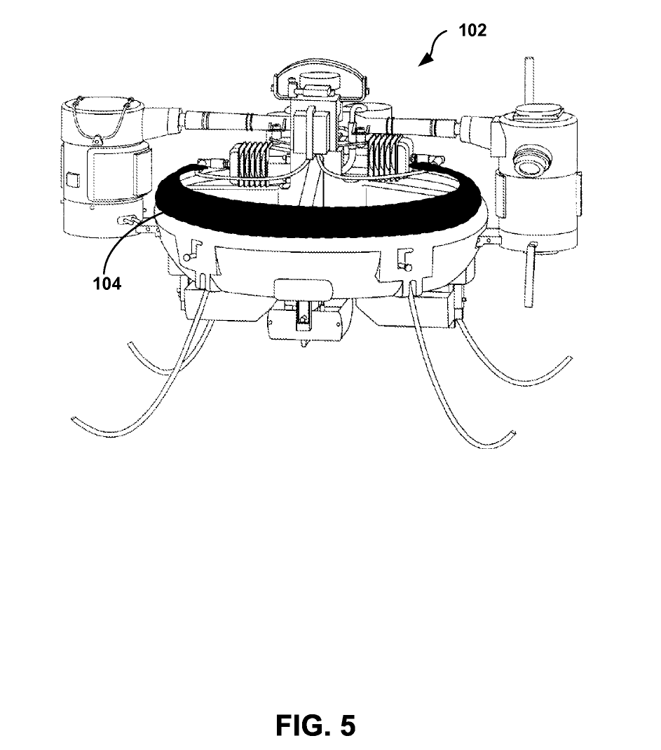

UAVs (e.g., UAV 102 of FIG. 5) may pose unique sets of challenges due to the nature of the missions in which UAVs are used, and additionally due to the size and weight demands associated with such vehicles. One such challenge has been to develop a reliable, closed fuel system that ensures a substantially consistent flow (e.g., consistent or nearly consistent) of fuel to the engine of the UAV regardless of the pitch, yaw, or roll of the UAV, where the closed fuel system can be relatively quickly de-fueled and fueled prior to every flight. One solution to this challenge has been to create a collapsible closed fuel container, such as fuel bladder, that can be filled with a measured amount of fuel and deliver a substantially consistent flow of fuel to the engine of the UAV regardless of the flight angle of the UAV.

FIG. 5 shows a conceptual illustration of an example UAV 102 including a closed fuel container 104 installed within UAV 102. Closed fuel container 104 may take on the form of a collapsible fuel bladder configured to deliver substantially consistent flow of fuel to UAV 102 regardless of the pitch, yaw, or roll of the vehicle. Effective fueling and use of the closed fuel container 104 requires that the container contains a set amount of fuel and is substantially free of any headspace over the fuel (e.g., free of visible amounts of air or other gases). If the headspace is not removed from closed fuel container 104, the air or other gases entrapped in the container may be inadvertently introduced into the fuel lines and engine of UAV 102 during flight, resulting in engine sputtering, stalling, and even loss of UAV 102. These attributes make the electric fueler and describe methods of the present invention uniquely compatible for use with UAV 102, though use with other UAVs benefiting from a closed fuel container 104 is also contemplated.

In some examples, filling of the closed fuel container 104 has employed a manual filling process, which involves using a syringe-like device to de-fuel and refuel the closed fuel container 104, thereby removing all visible amounts of air present in the closed fuel container and delivering a set amount of fuel to the closed fuel container. This process, however, can be exceptionally user and time intensive and prone to user errors.

In some examples, the efficiency of the manual process may be improved by incorporating an electric fueler such as the electric fueler described in U.S. Pat. No. 8,225,822 B2 to Erben et al., which is entitled, “Electric Fueling System for a Vehicle That Requires a Metered Amount of Fuel,” issued on Jul. 24, 2012, and is hereby incorporated-by-reference in its entirety. In some examples, an electric factor may employ a process of de-fueling a closed fuel container by engaging a fuel pump that pumps unused fuel from the closed fuel container of the UAV (or other vehicle) back into a fuel canister. Once the fuel has been evacuated from the closed fuel container, the flow direction of the fuel pump is reversed and the closed fuel container is filled with a set amount of fuel from the fuel canister. In some examples, to ensure that visible amounts of air are not introduced into the closed fuel container, the overall process may be repeated several times to flush and purge the closed fuel container and fueling lines of entrapped air.

Despite adherence to the above process, it was observed, during flight operations that disruptions in the fuel supply to the engine of a UAV 102 were still occurring, resulting in engine fluxuations, reduction in RPMs, and, in some instances, engine stalling. Upon further investigation, it was discovered that air or other gases were still somehow being introduced into the closed fuel system despite efforts to remove all gases from the closed fuel container 104 of UAV 102. In some examples, the observed amount of air or other gases, e.g., the headspace, present in the closed fuel container 104 accounted for as much about 18% of the filled volume of the closed fuel container. In some examples, the observed amount of air or other gases present in the closed fuel container 104 accounted for as much about one third of the filled volume of the closed fuel container.

Upon further investigation it was also observed the total volume of headspace present in the closed fuel container appeared to be dependent on the relative temperature of the enclosed fuel and the ambient pressure where the closed fuel container was stored. Without wanting to be bound to a specific scientific theory, it was hypothesized that the headspace introduced into the closed fuel container 104 was the result of outgassing of air or other gases dissolved in the fuel itself being supplied to the closed fuel container 104. Thus, as the ambient pressure and/or the temperature or of the fuel changed, so did the saturation point of the dissolved gases, e.g., air, in the enclosed fuel, resulting in an outgassing of the dissolved gasses and the creation of the headspace within the closed fuel container 104. A temperature rise of about 20 degrees Fahrenheit (° F.) to about 30° F. may cause automotive and aviation gasoline to outgas up to 15% of its volume, which may be detrimental to engine performance if the gases are ingested by the engine.

Several experiments were conducted to determine how the formation of the headspace within closed fuel container 104 may be reduced or even prevented. One such method developed included the application of a vacuum pressure on a headspace over the fuel in a fuel container (other than closed fuel container 104) as described in further detail below, to draw dissolved air or other dissolved gases out of the fuel, thereby reducing the amount of dissolved gases in the fuel. In some examples, the application of the vacuum pressure on the headspace over the fuel may create a fuel substantially free of dissolved gases. The resulting degassed fuel was then pumped into the closed fuel container 104. Table 1 below shows examples of degassed fuels obtained from the described process that there were found to be substantially free of dissolved gases. A total of three degassed fuel samples were prepared and tested with respective control samples that did not undergo the degassing process. Approximately 77 cubic inches (e.g., about 1.27 liters) degassed fuel and control fuels were pumped into respective closed fuel containers in the form of a collapsible fuel bladder without any visible gaseous headspace in the closed fuel containers. The temperature of the fuel in each closed fuel container was then subsequently heated from about 65° F. to about 120° F. (e.g., about 18.3° C. to about 48.9° C.), from about 67° F. to about 100° F. (e.g., about 19.4° C. to about 37.8° C.), and from about 100° F. to about 130° F. (e.g., about 37.8° C. to about 48.9° C.). The reduction in headspace volume for each of the degassed fuel test samples were then compared to the respective controls with the results recorded in Table 1. The degassed fuels demonstrated an overall reduction of at least about 60% in volume of dissolved gasses that outgas from the fuel over a temperature increased compared to a baseline fuel that had not been subjected to the vacuum pressure (“Control” in Table 1).

TABLE 1

| | Control | Example 1 | Example 2 | Example 3 |
|---|---|---|---|---|
| Volume of fuel | 77 in³ | 77 in³ | 77 in³ | 77 in³ |
| | [~1.26 L] | [~1.26 L] | [~1.26 L] | [~1.26 L] |
| Vacuum pressure exerted | NA | −7 inHg gauge | −7 inHg gauge | −7 inHg gauge |
| | | [~(−170 mmHg)] | [~(−170 mmHg)] | [~(−170 mmHg)] |
| Duration of Vacuum | NA | ~1 min | ~1 min | ~1 min |
| Initial Headspace (fuel | 0% | 0% | 0% | 0% |
| temperature ~20° C.) | | | | |
| Temperature Range tested | Paired with | 65° F.-120° F. | 67° F.-100° F. | 100° F.-130° F. |
| | Examples | (18.3° C.-48.9° C.) | (19.4° C.-37.8° C.) | (37.8° C.-54.4° C.) |
| Headspace reduction | NA (0% | About 63% | About 80% | About 100% |
| compared to control (%) | reduction) | reduction | reduction | reduction |

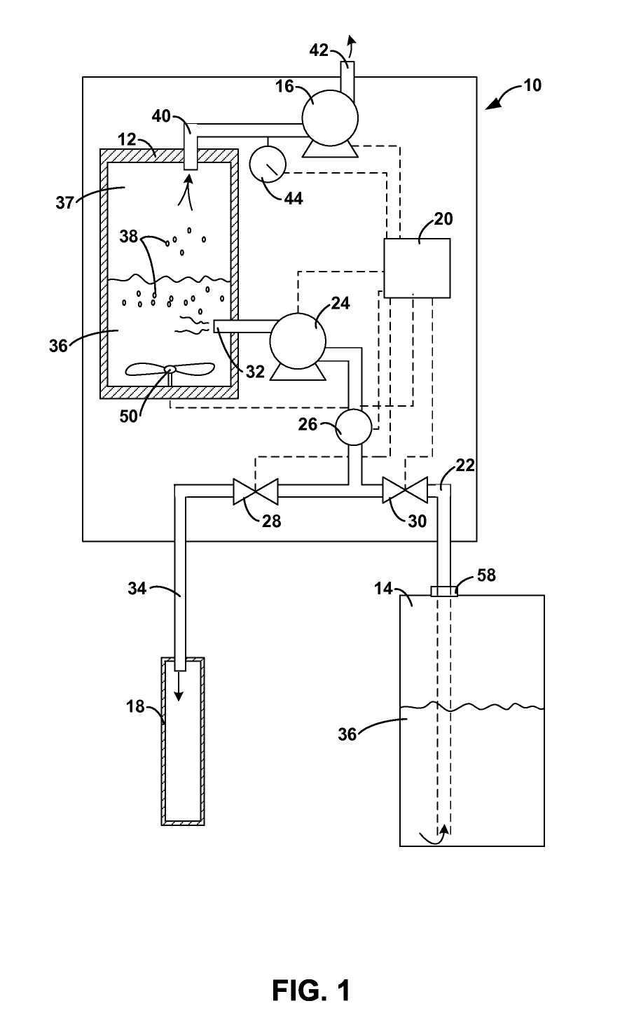

FIG. 1 shows a schematic diagram illustrating an example electric fueler 10 that is configured to degas a fuel that is introduced into a closed fuel container, e.g., closed fuel container 104 of UAV 102 (FIG. 5). Electric fueler 10 includes vacuum chamber 12, vacuum line 40, fuel supply line 22, fueling line 34, and controller 20. Vacuum chamber 12 connects to vacuum line 40 and includes agitator 50 and fuel inlet 32 connected to fuel supply line 22 and fueling line 34. Vacuum line 40 includes pressure gauge 44, vacuum pump 16, and exhaust port 42. Fuel supply line 22 includes supply solenoid 30, fuel meter 26, and fuel pump 24, where fuel supply line 22 connects to an external fuel canister 14 via an adapter 58. Fueling line 34 includes fueling solenoid 28 and connects vacuum chamber 12 to a closed fuel container 18, which can be an example of closed fuel container 104 of UAV 102. Controller 20 includes electrical connections configured to monitor and activate the various components of electric fueler 10 including vacuum pump 16, fuel pump 24, fuel meter 26, fueling solenoid 28, supply solenoid 30, pressure gauge 44, agitator 50, or the like.

Electric fueler 10 may be configured to introduce and receive a fuel 36 into vacuum chamber 12 from fuel canister 14 via fuel supply line 22 and deliver the fuel 36 to closed fuel container 18 after the fuel 36 has been degassed, e.g., after at least some of the dissolved air or other gases have been removed from fuel 36. As used herein, fuel canister 14 is a receptacle for receiving and fuel to electric fueler 10. Fuel canister 14 may take on any configuration, however, the canister should be large enough to hold enough fuel 36 to fill closed fuel container 18 as well as receive any unused fuel from closed fuel container 18 remaining from a previous flight. In some examples, fuel canister 14 may be a 5-gallon gas canister equipped with a self-venting apparatus so as to maintain ambient pressure inside fuel canister 14. In some examples fuel canister 14 may be connected to fuel supply line 22 via an adapter 58 equipped with a vent to equalize the pressure in fuel canister 14 during fueling or de-fueling. In some examples, electric fueler 10 may be configured such that fuel supply line 22 draws of deposits fuel 36 at the gravitational bottom of fuel canister 14 so as to minimize the introduction of air bubbles in fuel supply line 22. By depositing fuel 36 at the gravitational bottom of the fuel canister 14, any air bubbles will rise to the surface of the fuel 36 due to the effects of gravity, and purged by the vent located on fuel canister 14 or in adapter 58. Similarly, during the refueling process, during which fuel 36 is introduced into closed fuel container 18, electric fueler 10 draws fuel 36 from the gravitational bottom of fuel canister 14, preventing reintroduction of any air bubble into fuel supply line 22.

Vacuum chamber 12 may take on any configuration that is sufficient to withstand an internal vacuum pressure, such as an internal vacuum pressure of at least −170 millimeters of mercury (mmHg), without collapsing. For example, vacuum chamber 12 can be formed from a metal of sufficient thickness to withstand the vacuum pressure. As shown in FIG. 1, in some examples, vacuum chamber 12 may include a fuel inlet 32 positioned towards the gravitational bottom of vacuum chamber 12 and a vacuum line 40 positioned towards the top of vacuum chamber 12 (e.g., over the headspace 37 above fuel 36) connected to a vacuum pump 16 and exhaust port 42. During degassing operation, fuel 36 may be introduced into vacuum chamber 12 by, for example, engaging vacuum pump 16 or a fuel pump 24, thereby drawing fuel 36 from fuel canister 14 into vacuum chamber 12. The introduced fuel 36 in vacuum chamber 12 only partially fills the chamber, maintaining some degree of a headspace 37 over the fuel 36 so that the vacuum pressure can be exerted on the enclosed headspace 37 rather than directly on the fuel 36.

In some examples, electric fueler 10 may also include a controller 20 configured to control and communicate with the various components of electric fueler 10 including vacuum pump 16, fuel pump 24, solenoid valves 28 and 30, fuel meter 26, pressure gauge 44, or any combination thereof. Controller 20 may include a processor and a user interface configured to receive user input designating specific tasks to be conducted by electric fueler 10 including, for example, one or more of: a de-fueling operation to remove all unused fuel from closed fuel container 18; a purging and flushing operation to remove all air bubbles from closed fuel container 18, fuel supply line 22, and fueling line 34; a fueling and degassing operation to partially fill vacuum chamber 12 with fuel 36 and draw a vacuum over the fuel 36 to remove dissolved gases 38 and subsequently deliver the degassed fuel to closed fuel container 18.

In some examples, the processor of controller 20 may include one or more digital signal processors (DSPs), general purpose microprocessors, application specific integrated circuits (ASICs), field programmable logic arrays (FPGAs), or other equivalent integrated or discrete logic circuitry, of combinations thereof. The functions attributed to processors or controllers described herein may be provided by a hardware device and embodied as software, firmware, hardware, or any combination thereof. For example, controller 20 may include a memory that stores instructions that, when executed by the processor, cause the processor or controller to perform one or more of the various functions described herein.

The user interface of controller 20 can include an input mechanism configured to receive input from the user. The input mechanisms may include, for example, one or more of: buttons, a keypad (e.g., an alphanumeric keypad), a peripheral pointing device, a touchscreen display, or another suitable input mechanism. In addition, the user interface can include a display, such as a liquid crystal display (LCD) or light emitting diode (LED) display or other type of screen, with which controller 20 may present information to the user.

In some examples, controller 20 of electric fueler 10 may be configured to conduct a flush and purge operation to remove all unused fuel from closed fuel container 18 and purge all air from closed container 18, fuel supply line 22, and fueling line 34. In some examples, the operation may be conducted by controller 20 opening fueling solenoid 28 and engaging fuel pump 24 to extract any residual fuel 36 and air bubbles from closed fuel container 18 into vacuum chamber 12. Vacuum chamber 12 thereby acts as a fuel-gas separator, allowing air bubbles contained in fuel 36 to physically separate from the fuel. After the residual fuel has been withdrawn from closed fuel container 18, controller 20 may open fuel supply solenoid 30 to draw additional fuel 36 into vacuum chamber, thereby purging fuel supply line 22 of any air bubbles. Controller 20 may then close fuel supply solenoid 30 and reverse the flow direction of fuel pump 24 to partially fill closed fuel container 18 with fuel 36 contained in vacuum chamber 12. The total amount of fuel 36 pumped into closed fuel container 18 may be controlled by controller 20, e.g., by monitoring the amount of fuel being pumped into closed fuel container 18 via fuel meter 26, which may help ensure closed fuel container 18 is not over filled. Controller 20 may repeat this process one or more times to remove air bubbles from closed container 18, fuel supply line 22, and fueling line 34.

Controller 20 may also be configured to perform a fueling and degassing operation. During the fueling and degassing operation, controller 20 may close fueling solenoid 28, open fuel supply solenoid 30, and engage fuel pump 24 to withdraw fuel 36 from fuel canister 14 to partially fill vacuum chamber 12. Electric fueler 10 may be configured to regulate the total amount of fuel 36 introduced into vacuum chamber 12 using a variety of techniques. For example, controller 20 may monitor fuel meter 26 and send a signal to fuel pump 24 to shut the pump off after a pre-programed amount of fuel 36 (e.g., 1 to 2 gallons) have been introduced into vacuum chamber 12. In other examples, vacuum chamber 12 may contain a float (not shown) configured to signal controller 20 after a pre-programed level of fuel 36 is introduced into vacuum chamber 12.

In some examples, once fuel 36 has partially filled vacuum chamber 12, controller 20 may close fuel inlet 32, e.g., by closing solenoid valve 30, so that vacuum chamber 12 can be depressurized by a vacuum source (e.g., vacuum pump 16 or the like). Controller 20 may then activate or otherwise engage vacuum pump 16 to establish a vacuum pressure on headspace 37. As the vacuum pressure is exerted on headspace 37 over fuel 36, gasses dissolved in the fuel (hereinafter “dissolved gases 38”) are drawn out of fuel 36 into headspace 37. In some examples, dissolved gases 38 are exhausted from electric fueler through an exhausted port 42, however, depending on local environmental regulations, dissolved gases 38 may need to undergo further treatment prior to release into the atmosphere.

In some examples, degassing of fuel 36 may be accelerated by agitating fuel 36 during the degassing process. Agitation of fuel 36 may be accomplished though any suitable means. For example, agitation of fuel 36 may be accomplished by engaging an agitator 50, which can be a mixer located inside vacuum chamber 12 or another device configured to cause fuel 36 to move within vacuum chamber 12. In other examples, fuel 36 may be agitated by the introduction of fuel 36 into vacuum chamber 12 via fuel inlet 32. In such examples, fuel supply line 22 may be configured with a flow regulator that allows the vacuum chamber 12 to maintain the vacuum pressure on headspace 37 as fuel 36 is simultaneously withdrawn from fuel canister 14 and introduced into vacuum chamber 12. In other examples, fuel 36 may be agitated by manually or mechanically shaking vacuum camber 12.

In some examples, the removal of dissolved gases 38 from fuel 36 may be accomplished by exerting a vacuum pressure at or below about −170 mmHg (e.g., −170 mmHg or near −170 mmHg) on headspace 37, for approximately 60 seconds. In some examples, the vacuum pressure may be maintained for a shorter duration by exerting greater amounts of agitation on fuel 36 and/or further decreasing the pressure on over fuel 36 to exert greater vacuum pressure on headspace 37. In some examples, the vacuum pressure may be maintained for more than 60 seconds at or below about −170 mmHg.

In some examples, the removal of dissolved gases 38 from fuel 36 may be accomplished by decreasing the pressure on headspace 37 to about −170 mmHg over the course of several seconds (e.g., a rate of change of about 6 mmHg/s) while agitating fuel 36 to produce a fuel substantially free of dissolved gas 38.

After vacuum pump 16 has established the vacuum pressure on headspace 37 for an amount of time sufficient to remove at least some dissolved gases 38 from fuel 36, e.g., when fuel 36 is substantially free of dissolved gases 38, controller 20 may open fueling solenoid 28 and activate fuel pump 24 in a reverse direction to transport fuel 36 from vacuum chamber 12 to closed fuel container 18 via fueling line 34. In some examples, to aid in the transfer of fuel 36 from vacuum chamber 12 to closed fuel container 18, controller 20 may return the internal pressure of vacuum chamber 12 to ambient pressure by allowing air or an inert gas to fill headspace 37. The introduction of air into headspace 37 may temporarily expose the top layer of fuel 36 to air. However, because the exposure is relatively limited (e.g., on the order of a few seconds) the amount of air reintroduced into fuel 36 is relatively insignificant compared to the amount of dissolved gases 38 removed from fuel 36 during the degassing process described above. In some examples, fuel 36 may still remain substantially free of dissolved gases 38 even after the introduction of trace amounts of air in closed fuel container 18 because the degased fuel 36 has the potential to absorb and retain trace amounts of air in solution with releasing it during normal conditions.

In sonic examples, controller 20 also may be programed with various safety protocols. For example, controller 20 may be configured to shut off vacuum pump 16 and indicate a system leak if pressure gauge 44 does not obtain a certain pressure (e.g., −170 mmHg) within an allotted time frame (e.g., 2 minutes). In some examples, controller 20 may configured to monitor the meter 26 to verify whether the fuel flow rate is low or zero during the filling or discharging of vacuum chamber 12 or closed fuel container 18 and signal an error to the user. A low or zero flow rate may indicate an improper connection with fuel canister 14 or closed fuel container 18 or it may indicated air present in fuel supply line 22 or fueling line 34. Controller 20 also may be configured with a variety of user interactive controls. For example, controller 20 may include a SET FUEL switch that triggers fuel pump 24 to deliver a specified amount of fuel from vacuum chamber 12 to closed fuel container 18, a STEP FUEL switch that triggers fuel pump 24 to deliver an incremental amount of fuel (e.g., 20% of the total amount of fuel to be delivered) from vacuum chamber 12 to closed fuel container 18, a DE-FUEL switch that triggers fuel pump 24 evacuate fuel from closed fuel container 18 into either vacuum chamber 12 or fuel canister 14 depending on selection. Each of these switches may be activated by a user via a manual switch or via an electronic switch, e.g., via a digital display user interface provided by controller 20.

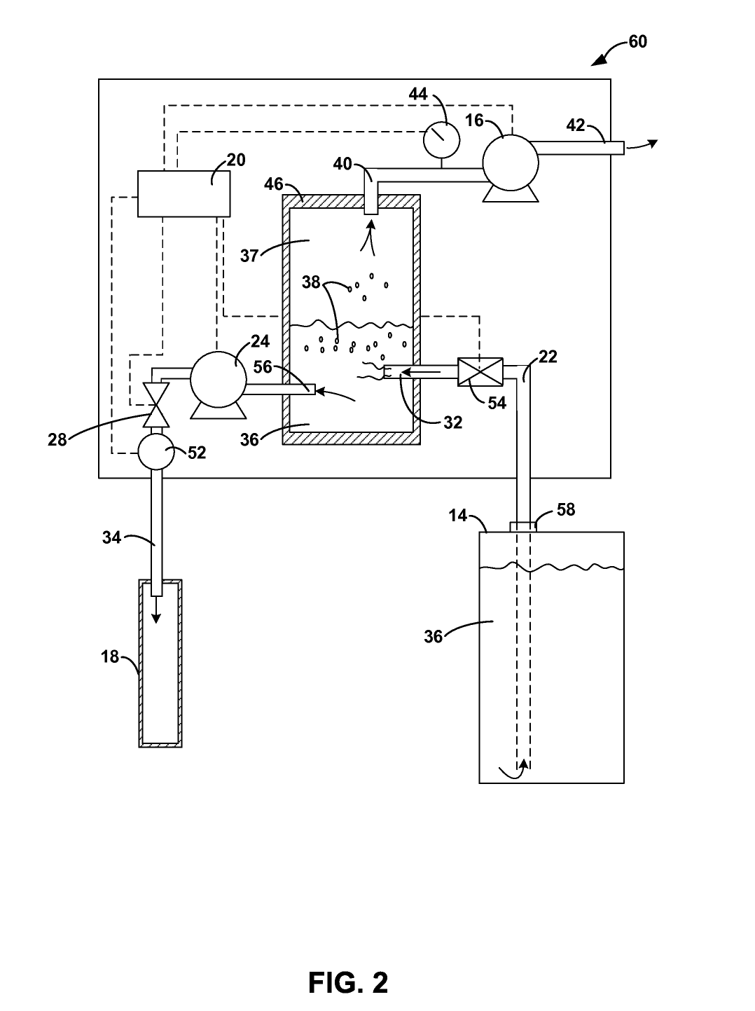

While the above fueling and degassing operation is described as an incremental process involving first degassing a set quantity of fuel 36 and subsequently filling closed fuel container 18 the degassed fuel, in some examples the fueling and degassing operation may be a continuous process. For example, FIG. 2 shows a schematic diagram illustrating another example of an electric fueler 60 that includes a vacuum chamber 46 configured to conduct either an incremental or continuous fueling and degassing operation. As shown, vacuum chamber 46 includes a fuel inlet 32 and a fuel outlet 56 connected to the bottom of vacuum chamber 46. In this configuration, electric fueler 60 may be configured so vacuum pump 16 establishes a vacuum pressure on headspace 37, thereby drawing fuel 36 into vacuum chamber 46 through fuel inlet 32 and removing dissolved gases 38 from fuel 36. Controller 20 governs the amount of fuel drawn into vacuum chamber 46 using flow regulator 54 so that the entire contents of fuel canister 14 is not siphoned into vacuum chamber 46 as a result of the vacuum pressure. While fuel 36 is drawn and degassed in vacuum chamber 46, controller 20 may simultaneously engage fuel pump 24 to transfer fuel 36 from vacuum chamber 46 via fuel outlet 56 to closed fuel container 18. Controller 20 may monitor the amount of fuel 36 delivered to closed fuel container 18 by a fuel meter 52 attached to fueling line 34.

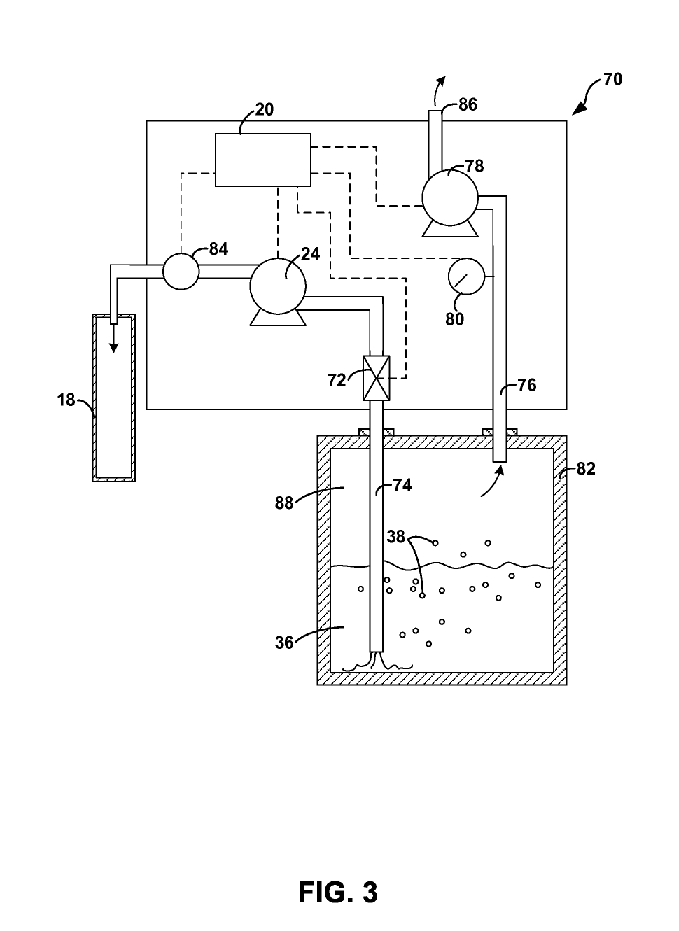

In some examples, degassing of fuel 36 may be conducted on a container separated from the electric fueler. For example, FIG. 3 shows a schematic diagram illustrating an example of an electric fueler 70 attached to a reinforced fuel canister 82 that also functions as a vacuum chamber capable of withstanding an internal vacuum pressure (e.g., at least −170 mmHg) without collapsing. Electric fueler 70 may be attached to reinforced fuel canister 82 by a fuel supply line 74 and a vacuum line 76. In some examples, fuel supply line 74 and vacuum line 76 may be formed by a single fuel line, while in other examples, fuel supply line 74 and vacuum line 76 may be formed by two distinct lines. As shown in FIG. 3, electric feeler 70 may contain a vacuum pump 78 attached to vacuum line 76 and controlled by controller 20. To degas fuel 36, controller 20 may engage vacuum pump 78 to decrease the pressure of headspace 88 as described above with respect to headspace 37 in FIG. 1, thereby resulting in dissolved gases 38 being removed from fuel 36 and exhausted through exhaust port 86.

In some examples, reinforced fuel canister 82 may he equipped with an agitator configured to stir, disrupt, or otherwise agitate fuel 36 as the vacuum pressure is drawn on headspace 88 over the fuel. In other examples, agitation of fuel 36 may be conducted by pumping fuel 36 into reinforce fuel canister 82 while the vacuum pressure is exerted over the fuel 36. For example, prior to drawing the vacuum pressure over fuel 36, controller 20 may first initiate fuel pump 24 to partially fill closed fuel container 18 (e.g., 80% filled) with fuel 36 via fuel supply line 74. After fuel pump 24 partially fills closed fuel container 18, controller 20 may stop fuel pump 24 and initiate vacuum pump 78 to decrease the internal pressure of reinforced fuel canister 82 to a target pressure. Once pressure gauge 80 reaches a certain level, controller 20 may operate flow regulator 72 to allow fuel 36 to he withdrawn from closed fuel container 18 back into reinforced fuel canister 82. The flow of fuel 36 into reinforced fuel canister 82 may be sufficient to agitate fuel 36 and aid in the removal of dissolved gases 38.

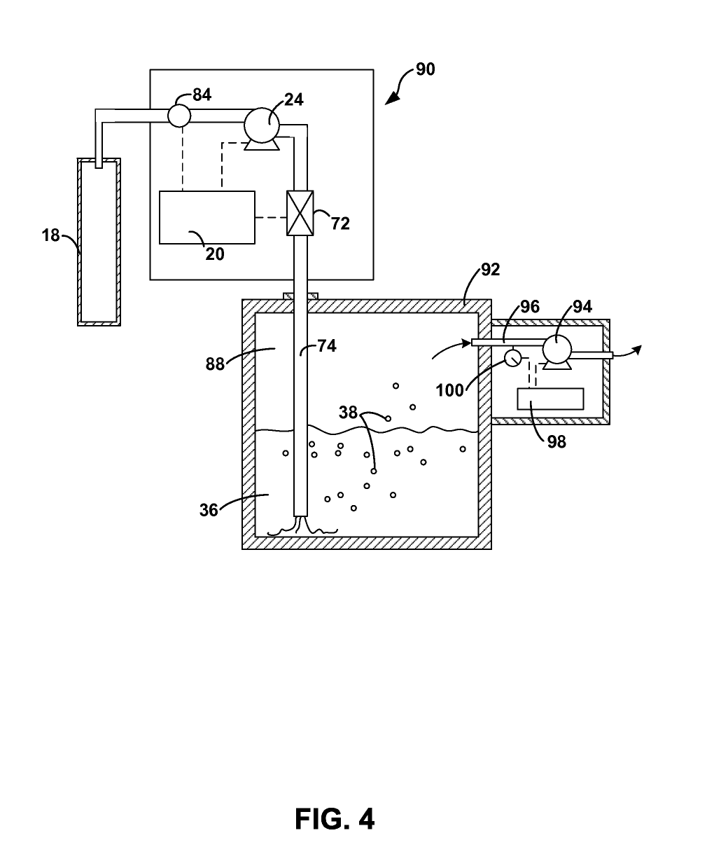

Additionally and alternatively, the vacuum pump assembly can be a separate from the electric fueler. For example, FIG. 4 shows a schematic diagram illustrating an example electric fueler 90 attached to a reinforced fuel canister 92 by a fuel supply line 74. The vacuum pump 94 is separated from electric fueler 90 and instead attached directly to reinforced fuel canister 92. Vacuum pump 94 may be configured to draw a vacuum on headspace 88 to remove dissolved gases 38 from fuel 36 as described above. In some examples, vacuum pump 94 may be controlled by a separate controller 98 configured to ate vacuum pump 94 until a target pressure is obtained as measured by pressure gauge 100. Controller 98 can be, for example, configured in the same manner as controller 20 described above with respect to FIG. 1.

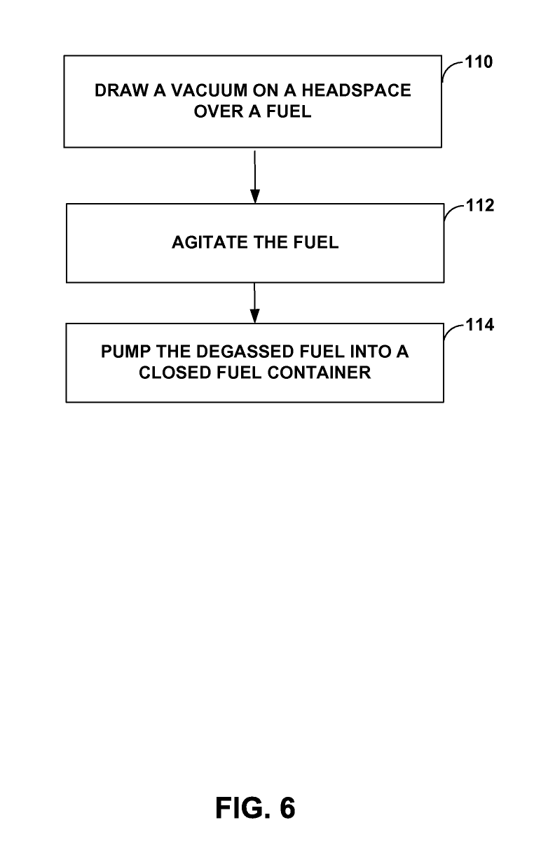

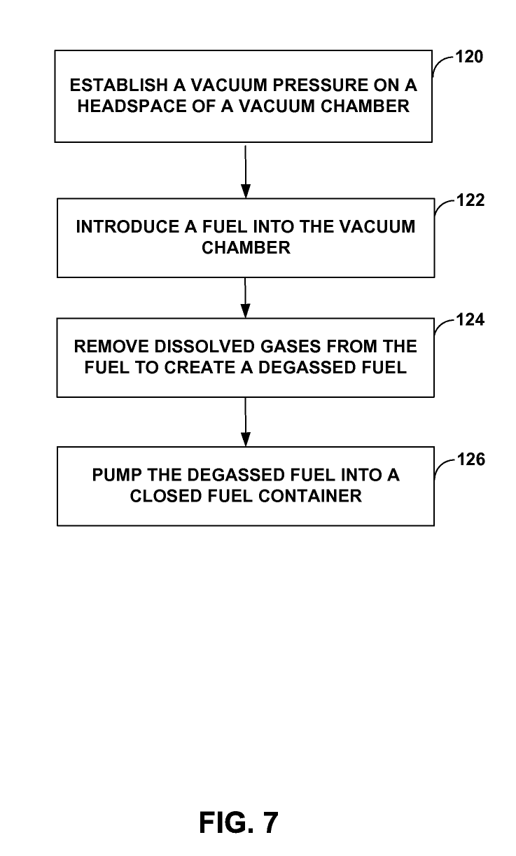

FIGS. 6 and 7 are flow diagrams illustrating example techniques for removing dissolved gases 38 from a fuel 36 and filling closed fuel container 18. FIGS. 6 and 7 are described below in reference to electric fueler 10 shown in FIGS. 1 for illustrative purposes, however, such descriptions are not intended to be limiting and the techniques of FIGS. 6 and 7 may be used in connection to other systems including those described with respect to FIGS. 2-4.

FIG. 6 illustrates an example technique that includes drawing a vacuum on a headspace 37 over a fuel 36 (110). For example, as described above, in order to draw the vacuum on headspace 37 (110), controller 20 may control vacuum pump 16 attached to a container 12 (also referred to herein as a “vacuum chamber”) capable of withstanding vacuum pressures below −170 mmHg gauge pressure without collapsing (e.g., vacuum chamber 12) to draw the vacuum on headspace 37. While fuel 36 is subjected to the vacuum pressure, fuel 36 may also be agitated (112) to accelerate the removal of dissolved gases 38. As described above, agitation of fuel 36 (112) may be conducted using an agitator 50, by pumping fuel 36 into vacuum chamber, or other means to physically disturb the fuel 36. After at least some dissolved gases 38 are removed from fuel 36 by the application of the vacuum, thereby resulting in a degassed fuel 36, the degassed fuel 36 may be pumped into a closed fuel container 18 (114) for use in an UAV 102. In some examples, fuel 36 is substantially free of dissolved gases 38 prior to being pumped into closed fuel container 18.

FIG. 7 illustrates another example technique for removing dissolved gases 38 from a fuel 36. The technique of FIG, 7 includes establishing a vacuum pressure on a headspace 37 of a vacuum chamber 12 (120) and introducing a fuel 36 into the vacuum chamber 12 (122), and removing dissolved gases 38 from the fuel 36 to create a degassed fuel (124). As describe above, the steps (120), (122), (124) may be performed in logical order or may be performed simultaneously. For example, under the control of controller 20, vacuum pump 16 may establish the vacuum pressure on vacuum chamber 12 (120) prior to the introduction of fuel 36. Controller 20 may then control fuel pump 24 to introduce fuel 36 into vacuum chamber 12 (122). The introduction of fuel 36 into vacuum chamber 12 (122) having the vacuum pressure causes dissolved gases 38 (o be removed from fuel 36 (124) and pulled into headspace 37. In some examples, fuel 36 may be introduced into vacuum chamber 12 (122) before the vacuum pressure is established on the headspace 37 (120). The vacuum pressure is then subsequently established (120) causing the dissolved gases 38 (e.g., at least sonic dissolved gases or substantially all dissolved gases) to be removed from fuel 36 (124). In some examples, establishing the vacuum pressure on the headspace 37 of vacuum chamber 12 (120) may occur simultaneously with the introduction of fuel 36 into vacuum chamber 12. After fuel 36 is substantially free of dissolved gases 38, the degased fuel may be pumped into closed fuel container 18 (126).

Various examples haw been described. These and other examples are within the scope of the following claims.

What is claimed is:

1. A method comprising:
drawing a vacuum on a headspace over a fuel in a first container to at east partially remove a dissolved gas from the fuel;
agitating the fuel while the fuel is under the vacuum; and
pumping the fuel from the first container into a closed fuel container, wherein the fuel pumped into the closed fuel container is substantially free of the dissolved gas.

2. The method of claim 1, wherein drawing the vacuum on the headspace: over the fuel comprises lowering a pressure of the headspace to about −170 mm of mercury gauge pressure or below −170 mm of mercury gauge pressure.

3. The method of claim 2, wherein the pressure of the headspace at or below about −170 mm of mercury gauge pressure is maintained for at least at least about 60 seconds.

4. The method of claim 1, further comprising partially filling the first container with the fuel, wherein drawing the vacuum on the headspace over the fuel comprises activating a vacuum source attached to the first container configured to draw the vacuum on the headspace over the fuel, wherein the vacuum source reduces a pressure of the headspace to at least about −170 mm of mercury gauge pressure.

5. The method of claim 4, further comprising substantially emptying the closed fuel container of air prior to pumping the fuel in to the closed fuel container.

6. The method of claim 1, wherein agitating the fuel while the fuel is under the vacuum comprises introducing the fuel into the first container.

7. The method of claim 1, wherein the fuel pumped into the closed fuel container demonstrates a least about a 60% reduction in volume of dissolved gasses that outgas from the fuel over a temperature rise from about 20 degrees centigrade to about 50 degrees centigrade compared to a baseline fuel that has not been subjected to the vacuum.

8. A method for filling a closed fuel container comprising:
establishing a vacuum pressure on a headspace of a vacuum chamber;
introducing a fuel into the vacuum chamber, wherein the fuel partially fills the vacuum chamber;
removing a dissolved gas from the fuel to create a degassed fuel; and
pumping the degassed fuel into a closed fuel container, wherein the closed fuel container is substantially free of a gas.

9. The method of claim 8, wherein the degassed fuel in the closed fuel container demonstrates a least about a 60% reduction in volume of dissolved gasses that outgas from the fuel over a temperature rise from about 20 degrees centigrade to about 50 degrees centigrade compared to a baseline fuel that has not been subjected to the vacuum pressure.

10. The method of claim 8, wherein the closed fuel container is in an unmanned aerial vehicle.

11. The method of claim 8, wherein establishing the vacuum pressure comprises decreasing a pressure of the headspace to at least about −170 mm of mercury gauge pressure or below about −170 mm of mercury gauge pressure.

12. The method of claim 11, further comprising maintaining the vacuum pressure at or below about −170 mm of mercury gauge pressure for at least at least about 60 seconds to remove the dissolved gas from the fuel.

13. The method of claim 8, wherein pumping the degassed fuel into the closed fuel container is conducted without exposing the degassed fuel to air.

14. The method of claim 8, wherein introducing the fuel into the vacuum chamber comprises introducing the fuel into the vacuum chamber after the vacuum pressure is at least partially established.

15. The method of claim 8, further comprising agitating the fuel in the vacuum chamber.

16. A system comprising:
a vacuum chamber configured to contain a fuel;
a vacuum source attached to the vacuum chamber and configured to draw a vacuum on a headspace over the fuel in the vacuum chamber; and
a fuel pump configured to pump the fuel from the vacuum chamber into a closed fuel container without introducing air into the closed fuel container.

17. The system of claim 16, further comprising the closed fuel container.

18. The system of claim 16, wherein the vacuum source is configured to reduce an internal pressure of a headspace of the vacuum chamber to at least about −170 mm of mercury gauge pressure or below about −170 mm of mercury gauge pressure.

19. The system of claim 16, further comprising a fuel supply line configured to attach to a fuel canister, wherein the fuel supply line connects to the vacuum chamber and is configured draw fuel from the fuel canister into the vacuum chamber as the vacuum source draws the vacuum on the vacuum chamber.

20. The system of claim 16, wherein the pump is configured to deliver a set amount of the fuel to the closed fuel container.
